(19) United States
(12) Patent Application Publication
(10) Pub. No.: US 2015/0366003 A1
(43) Pub. Date: Dec. 17, 2015

(54) ELECTRIC HEATING MODULE

(71) Applicant: Sceiba Intelligent Fashion Co., Ltd., Dongguan (CN)

(72) Inventor: Maochuan WANG, Dongguan (CN)

(21) Appl. No.: 14/739,795

(22) Filed: Jun. 15, 2015

(30) Foreign Application Priority Data
Jun. 16, 2014 (CN) 201410267101.5
Sep. 30, 2014 (CN) 201420570394.X

(51) Int. Cl. H05B 3/00; H05B 3/34; A41D 13/005; H05B 3/06

(52) U.S. Cl. CPC H05B 3/0014; H05B 3/06; H05B 3/342; A41D 13/0051

(57) ABSTRACT

An electric heating module includes at least one heating element, a connecting joint, a power cable and a power socket which are connected in turn, and the power socket being connected to an external power, the heating element including an extension segment and a retracing segment which is connected with the extension segment, the extension segment having a first end and the retracing segment having a second end, and the first end and the second end being adjacent to each other and connected to a positive joint and a negative joint of the connecting joint respectively. The electric heating module realizes two ends of the heating element being nearest and the length of the connecting line needed being shortest.

### RELATED APPLICATIONS

This application claims the benefit of priority to Chinese Patent Application No. 201410267101.5 and Chinese Patent Application No. 201420570394.X, the Chinese Patent Application No. 201410267101.5 which is hereby incorporated by reference in its entirety is filed on Jun. 16, 2014, and the Chinese Patent Application No. 201420570394.X which is hereby incorporated by reference in its part is filed on Sep. 30, 2014.

### FIELD OF THE INVENTION

The present invention relates to a technical field of clothing, and more specifically to an electric heating module.

### BACKGROUND OF THE INVENTION

Basic principles of electric heating device, such as electric jackets, electric vest, electric belts, etc, are converting electrical energy into heat energy through an electric heating module. And a typical electric heating module includes a power supply, a switch or temperature regulating component, a heating element and a wire joint or a wire plug or a socket which is connected to a circuit.

However, the electric heating module used for clothing has following disadvantages: the first one, the clothing is non-waterproof so that it can't be washed and electrical insulation performances of the product can't be guaranteed if a component of the electric heating module is wet; the second one, process in the garment processing is inconvenient as the clothing need an extra pocket to place the electric heating module which can't be sewn on the clothing directly for the sake of being stiff and thick; the third one, the clothing wears uncomfortable as the electric heating module is very heavy; the fourth one, it's inconvenient to use since the electric heating module which is an accessory rather than a component of the clothing need to be put on when needed or removed when not needed; the fifth one, since current products mostly use copper foils or alloy wires to generate heat, lots of energy radiated in a non-infrared way are wasted as can't be absorbed by bodies, therefore the heat energy generated when consuming equal electric energy is less, and the thermal efficiency is low; the sixth one, an internal surface of the current heating element is so opaque that the heat energy generated by the heating element can only be transferred to bodies in a heat conduction way, and can't be quickly transferred to bodies by the way of infrared radiation, and further because the electric heating module is thick and its heat capacity is big, it can only provide heat energy to bodies after itself is heated, therefore heat process is slow and heat loss is high; the seventh one, since the electric heating module without good elasticity can't be used for the clothing having a good elasticity, the electric heating device is not close to bodies, resulting in a low heat utilization rate; the eighth one, the heating element showed in FIG. 6 has a single route, that is the heating element has two ends called A and B respectively and the end A extends in a direction away from the end B, so a distance between the end A and the end B becomes more and more bigger with the increasing length of the heating element, thus two ends of the heating element are far apart from each other, therefore the length of a connecting line between the heating element and the connecting joint is big; the ninth one, the thermal resistance is big and the heat utilization rate is low since the current electric heating module uses a multi-layer structure and the heating element is sandwiched in the middle layer.

### SUMMARY OF THE INVENTION

An objective of the present invention is to provide an electric heating module in which two ends of the heating element are nearest and the length of the connecting line needed is shortest.

To achieve the objective, an electric heating module includes at least one heating element, a connecting joint, a power cable and a power socket, the connecting joint, the power cable and the power socket are connected in turn, the heating element is connected to the connecting joint, the power socket is adapted for connecting to an external power, the heating element has an extension segment and a retracing segment which is connected with the extension segment, the extension segment has a first end and the retracing segment has a second end, and the first end and the second end are adjacent to each other and connected to a positive joint and a negative joint of the connecting joint respectively.

Compared with the prior art, the heating element according to the present invention has an extension segment which has a first end and a retracing segment which has a second end, one terminal of the extension segment is connected with one terminal of the retracing segment, the first end and the second end are adjacent to each other and further connected to the positive joint and the negative joint of the connecting joint respectively, thus when the extension segment extends towards any one direction from the first end, the second end will be pulled back through the retracing segment which extends in a direction opposite to the direction of the extension segment, thereby making the first end be the nearest to the second end, and the length of the connecting line needed be the shortest.

Preferably, wherein the heating element has a double-route, and the extension segment forms a leave route by extending in a direction away from the connecting joint, and the retracing segment forms a return route by extending from the extension segment and in a direction opposite to the extending direction of the extension segment.

Preferably, the extension segment includes a first heating part, a first detour part, a second heating part and a connecting part which are connected with each other in turn, the retracing segment includes a third heating part, a second detour part and a fourth heating part which are connected with each other in turn, and the first end extends outward in straight lines to form the first heating part, an end of the first heating part bends and extends outward to form the first detour part, an end of the first detour part extends towards the first end in straight lines to form the second heating part, an end of the second heating part bends and extends towards the first end to form the connecting part, an end of the connecting part extends towards the first detour part in straight lines to form the third heating part, an end of the third heating part bends and extends towards the first detour part to form the second detour part, an end of the second detour part extends towards the first end in straight lines to form the fourth heating part, and an end of the fourth heating part extends towards the first end in straight lines to form the second end.

Preferably, the extension segment includes a first heating part, a first detour part, a second heating part, a third detour part, a sixth heating part and a connecting part which are connected with each other in turn, the retracing segment includes a third heating part, a second detour part, a fourth heating part, a fourth detour part and a seventh heating part which are connected with each other in turn, and the first end extends outward in straight lines to form the first heating part, an end of the first heating part bends and extends outward to form the first detour part, an end of the first detour part extends towards the first end in straight lines to form the second heating part, an end of the second heating part bends and extends in a direction away from the first end to form the third detour part, an end of the third detour part extends towards the first detour part in straight lines to form the sixth heating part, an end of the sixth heating part bends and extends in a direction away from the first end to form the connecting part, an end of the connecting part extends towards the third detour part in straight lines to form the seventh heating part, an end of the seventh heating part bends and extends towards the first end to form the fourth detour part, an end of the fourth detour part extends towards the first detour part in straight lines to form the third heating part, an end of the third heating part bends and extends towards the first end to form the second detour part, an end of the second detour part extends towards the first end in straight lines to form the fourth heating part, and an end of the fourth heating part extends towards the first end in straight lines to form the second end.

Preferably, the first detour part, the second detour part, the third detour part and the fourth detour part are circular arcs.

Preferably, an amount of the heating element is two, and the first ends or the second ends of the two heating elements are adjacent to each other.

Preferably, the heating element is made of Nano-alloy fibrils.

Preferably, the Nano-alloy fibrils are Fe—Ni—Cr—Mo alloy fibrils or Fe—Ni—Cr—Al alloy fibrils, and a diameter of a single Nano-alloy fibril is less than 20 micrometers.

Preferably, the heating element is coated by insulating materials whose hardness is less than Shore A 53 degrees and elongation at break is more than or equal to 300%.

Preferably, the electric heating module further includes a base fabric on which the heating element is fixed in an embroidery way, the base fabric is an elastic material product, and the heating element is connected to the connecting joint by crimping terminals, and the connecting joint is coated by an insulating casing.

The present invention will become more apparent from the following detailed description when taken in conjunction with the accompanying drawings used to illustrate embodiments of the invention.

### BRIEF DESCRIPTION OF THE DRAWINGS

FIG. 1 is a structural diagram of the electric heating module according to the present invention;

FIG. 2 is a first structural diagram of the heating element according to a first embodiment of the present invention;

FIG. 3 is a second structural diagram of the heating element according to a second embodiment of the present invention;

FIG. 4 is a structural diagram of the heating element showed in FIG. 1 when fixed on the base fabric;

FIG. 5 is a breakdown diagram of the heating element and the base fabric showed in FIG. 4;

FIG. 6 is a structural diagram of the routing according to current heating elements; and

FIG. 7 is a third structural diagram of the heating element according to a third embodiment of the present invention.

### DETAILED DESCRIPTION OF ILLUSTRATED EMBODIMENTS

Preferred embodiments of the present invention will be described taking in conjunction with the accompanying drawings below, and a similar component label in the drawings refers to a similar component.

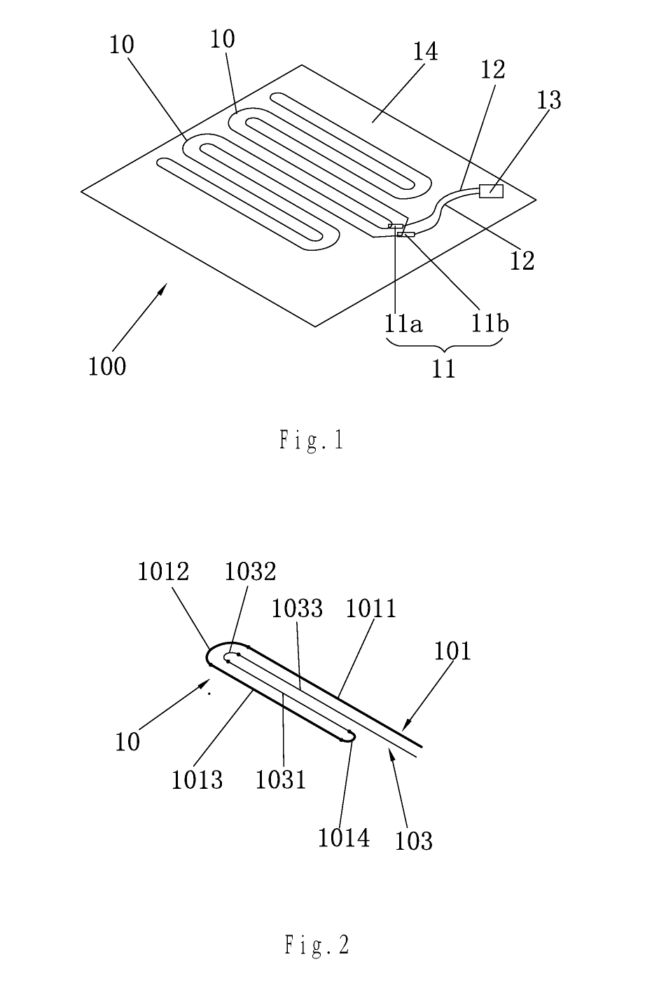

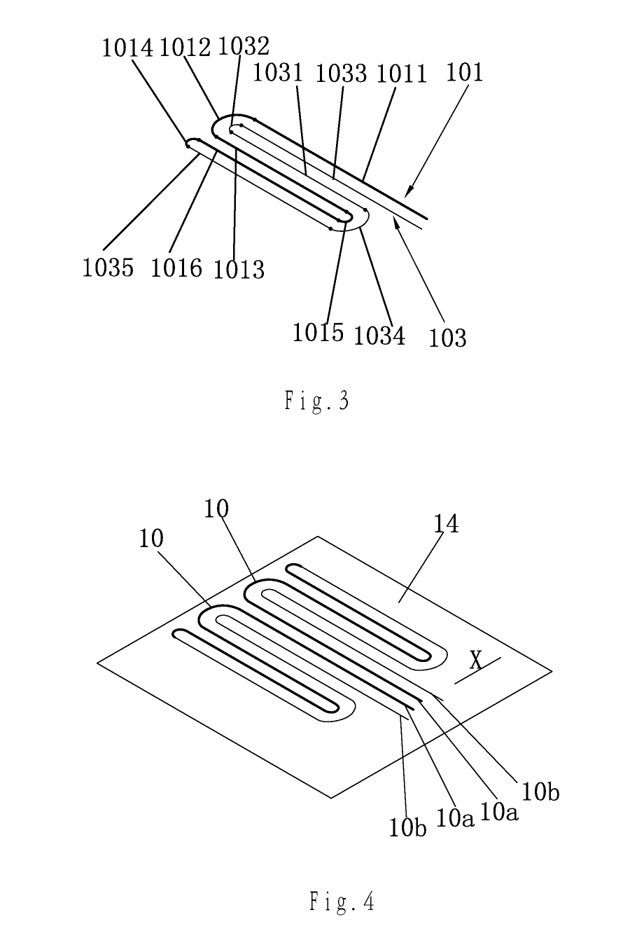

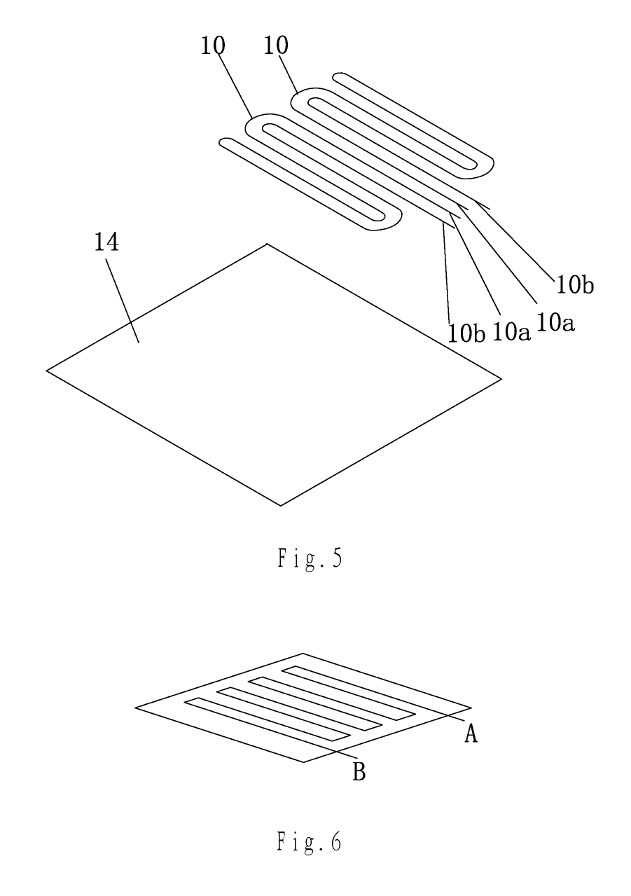

Please refer to FIG. 1˜FIG. 3, the electric heating module 100 of the present invention includes at least one heating element 10, a connecting joint 11, a power cable 12 and a power socket 13, the connecting joint 11, the power cable 12 and the power socket 13 are connected in turn. Concretely, the heating element 10 is connected to the connecting joint 11 through the power cable 12, the power cable 12 is connected to the power socket 13, and the power socket 13 is adapted for connecting to an external power so that the external power supplies electricity to the heating element 10 which is used for generating heat energy. More concretely, the heating element 10 has an extension segment 101 (the thick part showed on the FIG. 2˜FIG. 4) and a retracing segment 103 (the thin part showed on the FIG. 2˜FIG. 4, and to be sure, the thickness of the heating element 10 showed on the FIG. 2˜FIG. 4 is just used for distinguishing the extension segment 101 and the retracing segment 103 whose thickness are the same in reality), and one terminal of the extension segment 101 is connected to one terminal of the retracing segment 103, the other terminal of the extension segment 101 forms the first end 10a, the other terminal of the retracing segment 103 forms the second end 10b which is adjacent to the first end 10a, and the first end 10a and the second end 10b are connected to a positive joint 11a and a negative joint 11b of the connecting joint 11 respectively.

Furthermore, the heating element 10 has a double-route routing. Concretely, the extension segment 101 forms a leave route by extending in a direction away from the connecting joint 11, and the retracing segment 103 forms a return route by extending from the extension segment and in a direction opposite to the extending direction of the extension segment 101.

In one preferred embodiment of the present invention, the extension segment 101 as shown in FIG. 2 includes a first heating part 1011, a first detour part 1012, a second heating part 1013 and a connecting part 1014 which are connected with each other in turn, the retracing segment 103 includes a third heating part 1031, a second detour part 1032 and a fourth heating part 1033 which are connected with each other in turn, and the first end 10a extends outward in straight lines to form the first heating part 1011, an end of the first heating part 1011 bends and extends outward to form the first detour part 1012, an end of the first detour part 1012 extends towards the first end 10a in straight lines to form the second heating part 1013, an end of the second heating part 1013 bends and extends towards the first end 10a to form the connecting part 1014, an end of the connecting part 1014 extends towards the first detour part 1012 in straight lines to form the third heating part 1031, an end of the third heating part 1031 bends and extends towards the first heating part 1011 to form the second detour part 1032, an end of the second detour part 1032 extends towards the first end 10a in straight lines to form the fourth heating part 1033, and an end of the fourth heating part 1033 extends towards the first end 10 in straight lines to form the second end 10b. In the present embodiment, the heating element 10 extends towards the direction away from the first heating part 1011 through the first detour part 1012 of the extension segment 101, and then extends towards the direction approaching the first heating part 1011 through the second detour part 1032 of the retracing segment 103, thereby the extension segment 101 forming a leave route by extending towards the direction away from the connecting joint 11, and the retracing segment 103 forming a return route by extending towards the direction opposite to the extending direction of the extension segment 101. As a result, by the leave route and the return route, the first end 10a and the second end 10b of the heating element 10 are adjacent to each other, making two ends of the heating element 10 are closest, and the length of the connecting line needed be the shortest.

Please refer to FIG. 3, in another preferred embodiment, the extension segment 101 includes a first heating part 1011, a first detour part 1012, a second heating part 1013, a third detour part 1015, a sixth heating part 1016 and a connecting part 1014 which are connected with each other in turn, the retracing segment 103 includes a third heating part 1031, a second detour part 1032, a fourth heating part 1033, a fourth detour part 1034 and a seventh heating part 1035 which are connected with each other in turn. Concretely, the first end 10a extends outward in straight lines to form the first heating part 1011, an end of the first heating part 1011 bends and extends outward to form the first detour part 1012, an end of the first detour part 1012 extends towards the first end 10a in straight lines to form the second heating part 1013, an end of the second heating part 1013 bends and extends in a direction away from the first end 10a to form the third detour part 1015, an end of the third detour part 1015 extends towards the first detour part 1012 in straight lines to form the sixth heating part 1016, an end of the sixth heating part 1016 bends and extends in the direction away from the first end 10a to form the connecting part 1014, an end of the connecting part 1014 extends towards the third detour part 1015 in straight lines to form the seventh heating part 1035, an end of the seventh heating part 1035 bends and extends towards the first end 10a to form the fourth detour part 1034, an end of the fourth detour part 1034 extends towards the first detour part 1012 in straight lines to form the third heating part 1031, an end of the third heating part 1031 bends and extends towards the first end 10a to form the second detour part 1032, an end of the second detour part 1032 extends towards the first end 10a in straight lines to form the fourth heating part 1033, and an end of the fourth heating part 1033 extends towards the first end 10a in straight lines to form the second end 10b. In the present embodiment, the heating element 10 extends towards the direction away from the first heating part 1011 through the first detour part 1012 and the third detour part 1015 of the extension segment 101, and then extends towards the direction approaching the first heating part 1011 through the second detour part 1032 and the fourth detour part 1034 of the retracing segment 103, thereby the extension segment 101 forming a leave route by extending towards the direction away from the connecting joint 11, and the retracing segment 103 forming a return route by extending towards the direction opposite to the extending direction of the extension segment 101. Accordingly, by the leave route and the return route, the first end 10a and the second end 10b of the heating element 10 are adjacent to each other, making two ends of the heating element 10 are closest, and the length of the connecting line needed be the shortest.

To be clear, the first detour part 1012, the second detour part 1032, the third detour part 1015 and the fourth detour part 1034 can be designed to any shapes such as a right-angle or any others, and the shape in the present embodiment is an arc. In addition, FIG. 2 and FIG. 3 are only structural diagrams used for explaining two preferred embodiments of the heating element 10, but in reality, shapes of the leave route and the return route can be changed according to length limit and routing limit of the heating element 10. Of course, the extension segment 101 may include multiple detour parts, and then the retracing segment 103 may include multiple corresponding detour parts.

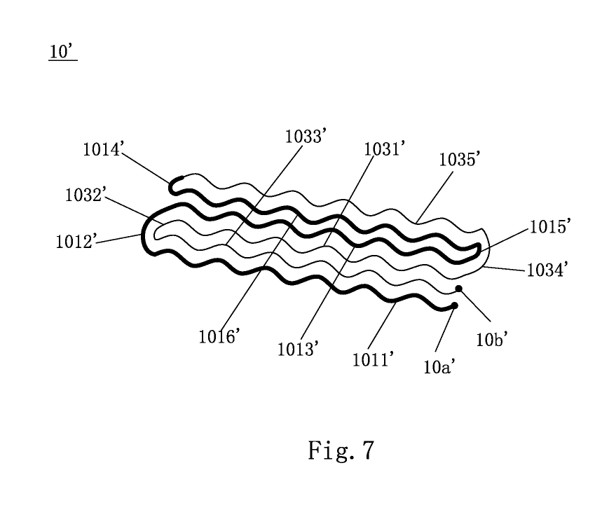

Please refer to FIG. 7, in a third embodiment of the heating element 10, the heating element 10 has an extension segment which has a first end 10a′ and a retracing segment which has a second end 10b′, and the extension segment includes a first heating part 1011′, a first detour part 1012′, a second heating part 1013′, a third detour part 1015′, a sixth heating part 1016′ and a connecting part 1014′ which are connected with each other in turn, the retracing segment includes a third heating part 1031′, a second detour part 1032′, a fourth heating part 1033′, a fourth detour part 1034′ and a seventh heating part 1035′ which are connected with each other in turn, and the first end 10a′ extends outward in wave lines to form the first heating part 1011′, an end of the first heating part 1011′ bends and extends outward to form the first detour part 1012′, an end of the first detour part 1012′ extends towards the first end 10a′ in wave lines to form the second heating part 1013′, an end of the second heating part 1013′ bends and extends in a direction away from the first end 10a′ to form the third detour part 1015′, an end of the third detour part 1015′ extends towards the first detour part1012′ in wave lines to form the sixth heating part 1016′, an end of the sixth heating part 1016′ bends and extends in a direction away from the first end 10a′ to form the connecting part 1014′, an end of the connecting part 1014′ extends towards the third detour part 1015′ in wave lines to form the seventh heating part1035′, an end of the seventh heating part 1035′ bends and extends towards the first end 10a′ to form the fourth detour part 1034′, an end of the fourth detour part 1034′ extends towards the first detour part 1012′ in wave lines to form the third heating part 1031′, an end of the third heating part 1031′ bends and extends towards the first end 10a′ to form the second detour part 1032′, an end of the second detour part 1032′ extends towards the first end 10a′ in wave lines to form the fourth heating part 1033′, and an end of the fourth heating part 1033′ extends towards the first end 10a′ in wave lines to form the second end 10b′.

Furthermore, the electric heating module 100 in the present embodiment includes two equally heating elements 10, and the first ends 10a or the second ends 10b of the two heating elements 10 are adjacent to each other. As shown in FIG. 4, the first ends 10a of the two heating elements 10 are adjacent to each other, and the connecting joint 11 is set at an intermediate position of the electric heating module 100. Besides, position of the connecting joint 11 located on the X direction showed in FIG. 4 can be adjusted by changing the length of the heating element 10.

Specifically, the heating element 10 is made of Nano-alloy fibrils and the Nano-alloy fibrils may be Fe—Ni—Cr—Mo alloy fibrils, Fe—Ni—Cr—Al alloy fibrils, etc. And a diameter of a single Nano-alloy fibril is less than 20 micrometers. Besides, the heating element 10 generates more energy when consuming equal electric energy since it uses Nano-alloy fibrils, meaning the heating element 10 has a higher thermal efficiency.

In addition, the heating element 10 is coated by insulating material whose hardness is less than Shore A 53 degrees and elongation at break is more than or equal to 300%. Specifically, the insulating material is transparent material of PTE whose infrared absorption rate is low, thus the heat energy generated by the heating element 10 may be quickly transferred to bodies by using an infrared radiation way and a heat conduction way at the same time. And further because the electric heating module 100 is very thin and its heat capacity is small, the heat energy wasted by temperature rising of the electric heating module 100 is small, thereby the heating element 10 in the present invention has a quicker heat process and a low heat loss compared with traditional heating element. Besides, since the insulating material has a good elasticity, the clothing having the electric heating module 100 is allowed to be close to bodies so that utilization rate for the heat energy is very high. Moreover, the heating element 10 coated with the insulating material is waterproof and washable so that electrical insulation performances of the heating element 10 are uninfluenced when it is wet.

Furthermore, as shown in FIG. 2 and FIG. 3, the electric heating module 100 further includes a base fabric 14 on which the heating element 10 is fixed on. And the base fabric 14 is an elastic material product so that the clothing having the electric heating module 100 is allowed to be close to bodies, therefore improving utilization rate for the heat energy. Besides, the heating element 10 is connected to the connecting joint 11 by crimping terminals, and the connecting joint 11 is coated by an insulating casing.

The electric heating module 100 according to the present invention has many advantages compared with the prior art, for example:

the first one, the electric heating module 100 is waterproof and washable so that electrical insulation performances of the heating element 10 are uninfluenced when it is wet or even washed;

the second one, process in the garment processing is convenient as the electric heating module 100 which is very soft and thin can be sewn on the clothing directly, and an extra pocket is not needed;

the third one, the clothing having the electric heating module 100 wears comfortable as the electric heating module 100 is very light;

the fourth one, the electric heating module 100 is convenient to use since it is an integral component of the clothing;

the fifth one, thermal efficiency of the electric heating module 100 is high since the heating element 10 is made of Nano-alloy fibrils which generates more energy when consuming equal electric energy;

the sixth one, the electric heating module 100 has a quicker heat process and a lower heat loss which Specifically, the insulating material is transparent material of PTE whose infrared absorption rate is low, thus the heat energy generated by the heating element 10 may be quickly transferred to bodies by using an infrared radiation way and a heat conduction way at the same time. And further because the electric heating module 100 is very thin and its heat capacity is small, the heat energy wasted by temperature rising of the electric heating module 100 is small, thereby the heating element 10 in the present invention has a quick heat process and a lower heat loss compared with traditional heating element.

the seventh one, the utilization rate for the heat energy is high and the clothing having the electric heating module 100 is allowed to be close to bodies since the electric heating module 100 has a good elasticity;

the eighth one, the distance between the positive joint and the negative joint and the length of the connecting line are shortest as the heating element takes a double-route;

the ninth one, the electric heating module 100 has a small thermal resistance and a high heat utilization rate since it uses a single layer structure. Concretely, the heating element 10 is fixed on the base fabric 14 in an embroidery way, and the base fabric 14 is screwed onto the clothing directly, thereby obtained a small thermal resistance and a high heat utilization rate compared with the current electric heating module which has a multiple-layer structure and of which the heating element is sandwiched in the middle layer.

While the present invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. An electric heating module, comprising at least one heating element, a connecting joint, a power cable and a power socket, the connecting joint, the power cable and the power socket being connected in turn, the heating element connecting to the connecting joint, the power socket being adapted for connecting to an external power, the heating element having an extension segment and a retracing segment which is connected with the extension segment, the extension segment having a first end and the retracing segment having a second end, and the first end and the second end being adjacent to each other and connected to a positive joint and a negative joint of the connecting joint respectively.

2. The electric heating module according to claim 1, wherein the heating element has a double-route, and the extension segment forms a leave route by extending in a direction away from the connecting joint, and the retracing segment forms a return route by extending from the extension segment and in a direction opposite to the extending direction of the extension segment.

3. The electric heating module according to claim 2, wherein the extension segment includes a first heating part, a first detour part, a second heating part and a connecting part which are connected with each other in turn, the retracing segment includes a third heating part, a second detour part and a fourth heating part which are connected with each other in turn, and the first end extends outward in straight lines to form the first heating part, an end of the first heating part bends and extends outward to form the first detour part, an end of the first detour part extends towards the first end in straight lines to form the second heating part, an end of the second heating part bends and extends towards the first end to form the connecting part, an end of the connecting part extends towards the first detour part in straight lines to form the third heating part, an end of the third heating part bends and extends towards the first detour part to form the second detour part, an end of the second detour part extends towards the first end in straight lines to form the fourth heating part, and an end of the fourth heating part extends towards the first end in straight lines to form the second end.

4. The electric heating module according to claim 2, wherein the extension segment includes a first heating part, a first detour part, a second heating part, a third detour part, a sixth heating part and a connecting part which are connected with each other in turn, the retracing segment includes a third heating part, a second detour part, a fourth heating part, a fourth detour part and a seventh heating part which are connected with each other in turn, and the first end extends outward in straight lines to form the first heating part, an end of the first heating part bends and extends outward to form the first detour part, an end of the first detour part extends towards the first end in straight lines to form the second heating part, an end of the second heating part bends and extends in a direction away from the first end to form the third detour part, an end of the third detour part extends towards the first detour part in straight lines to form the sixth heating part, an end of the sixth heating part bends and extends in a direction away from the first end to form the connecting part, an end of the connecting part extends towards the third detour part in straight lines to form the seventh heating part, an end of the seventh heating part bends and extends towards the first end to form the fourth detour part, an end of the fourth detour part extends towards the first detour part in straight lines to form the third heating part, an end of the third heating part bends and extends towards the first end to form the second detour part, an end of the second detour part extends towards the first end in straight lines to form the fourth heating part, and an end of the fourth heating part extends towards the first end in straight lines to form the second end.

5. The electric heating module according to claim 4, wherein the first detour part, the second detour part, the third detour part and the fourth detour part are circular arcs.

6. The electric heating module according to claim 1, wherein an amount of the heating element is two, and the first ends or the second ends of the two heating elements are adjacent to each other.

7. The electric heating module according to claim 1, wherein the heating element is made of Nano-alloy fibrils.

8. The electric heating module according to claim 7, wherein the Nano-alloy fibrils are Fe—Ni—Cr—Mo alloy fibrils or Fe—Ni—Cr—Al alloy fibrils, and a diameter of a single Nano-alloy fibril is less than 20 micrometers.

9. The electric heating module according to claim 1, wherein the heating element is coated by insulating materials whose hardness is less than Shore A 53 degrees and elongation at break is more than or equal to 300%.

10. The electric heating module according to claim 1, wherein the electric heating module further includes a base fabric on which the heating element is fixed in an embroidery way, the base fabric is an elastic material product, and the heating element is connected to the connecting joint by crimping terminals, and the connecting joint is coated by an insulating casing.

11. The electric heating module according to claim 2, wherein the extension segment includes a first heating part, a first detour part, a second heating part, a third detour part, a sixth heating part and a connecting part which are connected with each other in turn, the retracing segment includes a third heating part, a second detour part, a fourth heating part, a fourth detour part and a seventh heating part which are connected with each other in turn, and the first end extends outward in wave lines to form the first heating part, an end of the first heating part bends and extends outward to form the first detour part, an end of the first detour part extends towards the first end in wave lines to form the second heating part, an end of the second heating part bends and extends in a direction away from the first end to form the third detour part, an end of the third detour part extends towards the first detour part in wave lines to form the sixth heating part, an end of the sixth heating part bends and extends in a direction away from the first end to form the connecting part, an end of the connecting part extends towards the third detour part in wave lines to form the seventh heating part, an end of the seventh heating part bends and extends towards the first end to form the fourth detour part, an end of the fourth detour part extends towards the first detour part in wave lines to form the third heating part, an end of the third heating part bends and extends towards the first end to form the second detour part, an end of the second detour part extends towards the first end in wave lines to form the fourth heating part, and an end of the fourth heating part extends towards the first end in wave lines to form the second end.
